(19) United States
(12) Patent Application Publication
(10) Pub. No.: US 2021/0148779 A1
(43) Pub. Date: May 20, 2021

(54) A SYSTEM AND A METHOD FOR DETECTING MOISTURE COMPRISING A CABLE, A CABLE FOR DETECTING MOISTURE AND A MOISTURE DETECTION DEVICE

(71) Applicant: MIKRODUST AB, Lund (SE)

(72) Inventors: Mats Iderup, Lund (SE); Martin Johansson, Lund (SE)

(73) Assignee: MIKRODUST AB, Lund (SE)

(21) Appl. No.: 16/621,623

(22) PCT Filed: Jun. 15, 2017
(86) PCT No.: PCT/SE2017/050645

§ 371 Date: Dec. 11, 2019

(51) Int. Cl. G01M 3/16

(52) U.S. Cl. CPC G01M 3/165

(57) ABSTRACT

A moisture detection system (100) comprises a cable (102), a voltage regulator (104) and a differential amplifier (106). The cable (102) comprises an elongated non-conductive moisture permeable structure (108), a first elongated lead (110) and a second elongated lead (112). The first and second leads (110, 112) are substantially equal in length and are connected to the differential amplifier (106) and arranged such that they are not in galvanic contact with each other at any location along the cable (102). The voltage regulator (104) is configured to supply a regulated voltage to the first lead (110) and to the differential amplifier (106). The differential amplifier (106) is configured to determine a voltage difference between the first and second leads (110, 112), and configured to provide a signal that is representative of the determined voltage difference.

### TECHNICAL FIELD

Embodiments herein relate to systems, arrangements and methods for detection of moisture.

### BACKGROUND

Damage to property due to undesired presence of liquids, for example as a consequence of a leaking water pipe or leaking machinery, is a common problem in many types of environments, private as well as industrial. Needless to say, it is important to minimize such damages and the costs associated with the damages. This may of course be done by making every effort to prevent the leaks from occurring in the first place. But, nevertheless, having occurred anyway it is desirable to obtain an early, reliable and unambiguous detection of the leak.

Moreover, although leaks in the form of liquid may be very damaging, moisture in high humidity situations may also be undesirable. Depending on parameters such as temperature and pressure, moisture occurs when humid gas condenses. Even if the amount of condensed liquid may be limited in comparison with an amount of liquid flowing from a leaking pipe or vessel, it is nevertheless desirable to obtain an early, reliable and unambiguous detection of moisture even though its presence is not due to a leak.

Prior art moisture detection arrangements include a fluid detection cable as described in U.S. Pat. No. 6,144,209, where elongated conductive members are located in grooves along an elongated and twisted non-conductive flexible base member. The conductive members are coated with a non-conductive water-insoluble liquid pervious coating. The cable is connected to a control system that generates an alarm when fluid gets in contact with the conductive members.

Drawbacks with such a cable include mechanical limitations such as stiffness that makes it difficult to arrange the cable in full contact with a floor surface.

The prior art also includes liquid permeable coaxial cables. For example a coaxial cable where a central conductor is covered by a layer of isolating yarn, which in turn is covered by a braided screen of mixed conductor and polyester yarns and an outermost braiding of polyester yarn.

Although such prior art moisture detection arrangements are able to detect moisture to some extent, there remain drawbacks that need attention, for example regarding untimely, unreliable and ambiguous moisture detection.

### SUMMARY

In view of the above, an object of the present disclosure is to overcome or at least mitigate at least some of the drawbacks related to prior art moisture detection arrangements.

This is achieved in a first aspect by a moisture detection system that comprises a cable, a voltage regulator and a differential amplifier. The cable comprises an elongated non-conductive moisture permeable structure, a first elongated lead and a second elongated lead. The first and second leads are substantially equal in length and are connected to the differential amplifier and arranged such that they are not in galvanic contact with each other at any location along the cable. The voltage regulator is configured to supply a regulated voltage to the first lead and to the differential amplifier. The differential amplifier is configured to determine a voltage difference between the first and second leads, and configured to provide a signal that is representative of the determined voltage difference.

In other words, such a system enables moisture detection by the fact that, when the cable is subjected to moisture there will run an electric current through the two leads. Depending on what kinds of molecules are present in the moisture, this current will vary in size. In any case, disregarding any absolute value of the current, the current will result in a voltage drop from the first lead to the second lead. Since the leads are connected to the differential amplifier, the signal provided by the differential amplifier will be representative of the voltage drop between the two leads and therefore also representative of the moisture. This is advantageous in that it is a simple system and thereby easy and cheap to produce. Due to the fact that a differential amplifier is very sensitive to voltage differences, early detection of even small amounts of moisture is possible.

Moreover, due to the fact that the two leads are of equal length, any external influence from electric fields from, e.g., electric machinery, power cables and fluorescent lamps will affect both leads in a similar manner. As a consequence, there will be no electric potential difference between the two leads due to external electric fields. An advantage of this is that the moisture detection will be both reliable and unambiguous. That is, when the differential amplifier produces a signal, it is certain that the signal is due to a moist cable and not due to an external electric field present at the location of the cable. Needless to say, this is a common situation, not least in an environment with electric machinery, power cables and fluorescent lamps. This is in contrast to prior art moisture detection systems not using differential amplifiers. Typically, such prior art systems are therefore very sensitive to external electric fields and thereby are unable to achieve the advantages of the system of the present disclosure.

In some embodiments, the regulated voltage is in the form of constant voltage pulses having a duration DT1 and a repetition interval DT2. DT2 is greater than DT1 and, preferably, DT2 is at least one order of magnitude greater than DT1.

In other words, in these embodiments the regulated voltage is pulsed with duration DT1 and repeated every DT2. When moisture is present in the cable there will run an electric current through the cable and other circuitry in the system. By supplying such a pulsed regulated voltage the amount of electric energy used can be reduced. For example, in a case where the voltage regulator takes electric energy from a voltage source that is a battery an advantage of having a pulsed regulated voltage is that the battery life span can be increased.

In some embodiments, the voltage regulator and the differential amplifier are configured to receive pulses of unregulated voltage V1 from a voltage supply. The pulses of unregulated voltage V1 have the duration DT1 and the repetition interval DT2.

That is, in such embodiments, also the differential amplifier is provided with voltage in a pulsed manner and therefore minimizing the amount of use of energy from the voltage supply. This is particularly advantageous in a scenario where energy is provided to the system from a battery.

In some embodiments, the first elongated lead and the second elongated lead have a substantially constant distance from each other along the cable.

That is, such a configuration of the two leads will ensure that the cable will have a constant detection sensitivity to moisture along the length of the cable, This means that a specific amount of moisture will result in a specific representative signal provided by the differential amplifier, irrespective of at which position along the cable the specific moisture is located. In other words, such a configuration provides an unambiguous detection of moisture.

In some embodiments, the elongated non-conductive moisture permeable structure comprises a first braid of yarn and the first and second elongated leads are braided within the first braid of yarn. In some of these embodiments, the elongated non-conductive moisture permeable structure comprises a second braid of yarn arranged concentric with respect to, and covering, the first braid of yarn.

That is, by utilizing braided yarns it is possible to provide a cable that is very flexible and adaptable to any surface it is arranged at. For example, when arranged on a floor, the braided structure will enable the whole length of the cable to fall into contact with the floor without undesirable kinks that may cause the cable to be above the floor. An advantage of this is that moisture can be reliably detected by the system.

Furthermore, an advantage of utilizing braided yarn is that the two elongated leads may be easily incorporated into the first braid of yarn during a manufacturing process. That is, remembering that a braiding apparatus utilizes a plurality of rolls of yarn that are braided into a braid: by replacing two of the rolls of yarn with a respective first and a second roll of electric lead, little or no modification to the braiding apparatus or the actual braiding procedure is required.

The system may further be embodied as described in more detail below.

In another aspect there is provided a cable for detecting moisture. The cable comprises an elongated non-conductive moisture permeable structure, a first elongated lead and a second elongated lead. The first and second leads are substantially equal in length and arranged such that they are not in galvanic contact with each other at any location along the cable. The first and second leads are also configured to be connected to a voltage regulator and to a differential amplifier.

In a further aspect there is provided a moisture detection device that comprises a voltage regulator, a differential amplifier and a control unit. The control unit comprises a processor, a memory and communication circuitry. The voltage regulator is configured to supply a regulated voltage to the differential amplifier and to a first lead of a cable as summarized above. The differential amplifier is configured to determine a voltage difference between the first lead of the cable and a second lead of the cable, and configured to provide a signal that is representative of the determined voltage difference to the control unit. The control unit is configured to process the signal and configured to, as a result of the processing of the signal, perform a moisture detection related action. In yet another aspect there is provided a method performed by a control unit for detecting moisture. The control unit is connected to a system as summarized above and the method comprises:
controlling the voltage regulator to supply a regulated voltage to the first lead and to the differential amplifier,
receiving a signal that is representative of a determined voltage difference,
process the signal, and
performing, as a result of the processing of the signal, entity moisture detection related action.

These further aspects can be embodied, and have technical effects and advantages, that correspond to those summarized above in connection with the system for detecting moisture and further embodied as described in more detail below.

The expressions “substantially equal” and “substantially constant” used herein are to be interpreted in the respective context in which they occur. For example, “substantially equal” means that entities are equal within a typical manufacturing error or measurement error in the respective context.

### BRIEF DESCRIPTION OF THE DRAWINGS

FIG. 1 schematically illustrates a block diagram of a system for moisture detection,

FIG. 2 schematically illustrates a block diagram of a moisture detection device,

FIGS. 3a and 3b are schematically illustrated cross-sectional views of a cable,

FIG. 4 is a schematically illustrated combined block and circuit diagram of a system for moisture detection,

FIGS. 5a-c are schematically illustrated voltage diagrams in a system for moisture detection, and

FIG. 6 is a flowchart of a method performed in a control unit in a system for moisture detection.

### DETAILED DESCRIPTION

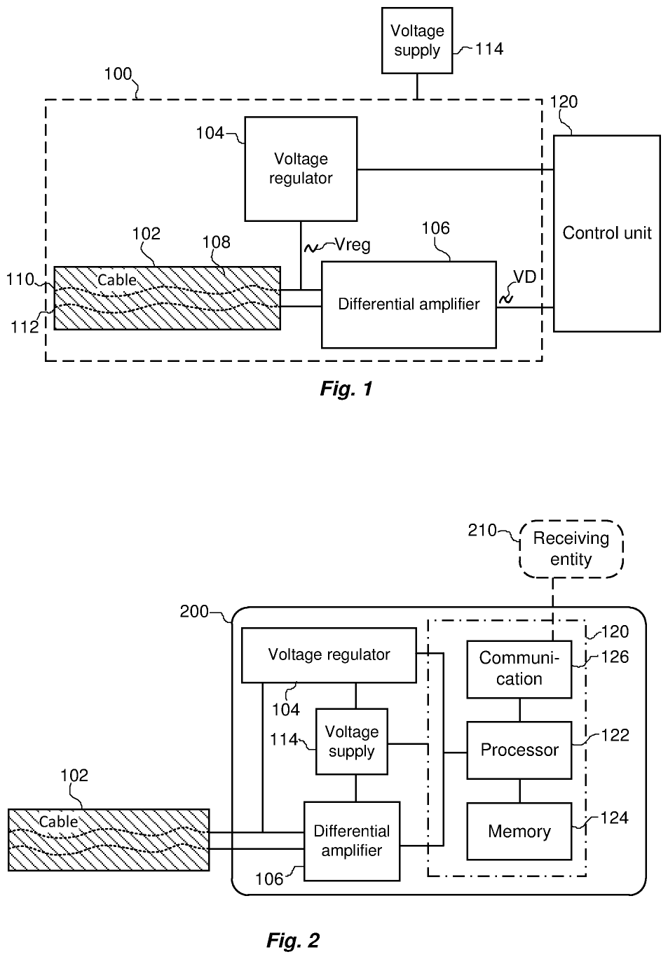

Referring first to FIG. 1, a system 100 for detecting moisture comprises a cable 102, a voltage regulator 104 and a differential amplifier 106. A control unit 120 is configured to interact with the system 100, as will be exemplified below. The cable 102 comprises an elongated non-conductive moisture permeable structure 108, a first elongated lead 110 and a second elongated lead 112. The first and second leads 110, 112 are substantially equal in length and connected to the differential amplifier 106. The first and second leads 110, 112 are arranged such that they are not in galvanic contact with each other at any location along the cable 102.

The voltage regulator 104 is configured to supply a regulated voltage Vreg to the first lead 110 and to the differential amplifier 106. As FIG. 1 exemplifies, a voltage supply 114 such as a battery or any other suitable energy source may be connected to the system 100 in order to provide necessary electric energy to the system 100, including the voltage regulator and other circuitry such as the differential amplifier 106.

The differential amplifier 106 is configured to determine a voltage difference between the first and second leads 110, 112, and it is also configured to provide a signal VD that is representative of the determined voltage difference between the two leads 110, 112.

While the regulated voltage Vreg is supplied to the first lead 110 and while the cable 102 is subjected to moisture there will run an electric current through the two leads 110, 112. Depending on what kinds of molecules are present in the moisture, this current will vary in size due to the fact that the impedance between the leads varies with the moisture level. In any case, disregarding any absolute value of the current, the current will result in a voltage drop from the first lead 110 to the second lead 112. Since the leads 110, 112 are connected to the differential amplifier 106 the signal VD provided by the differential amplifier 106 will be representative of the voltage drop between the two leads 110, 112 and therefore also representative of the moisture.

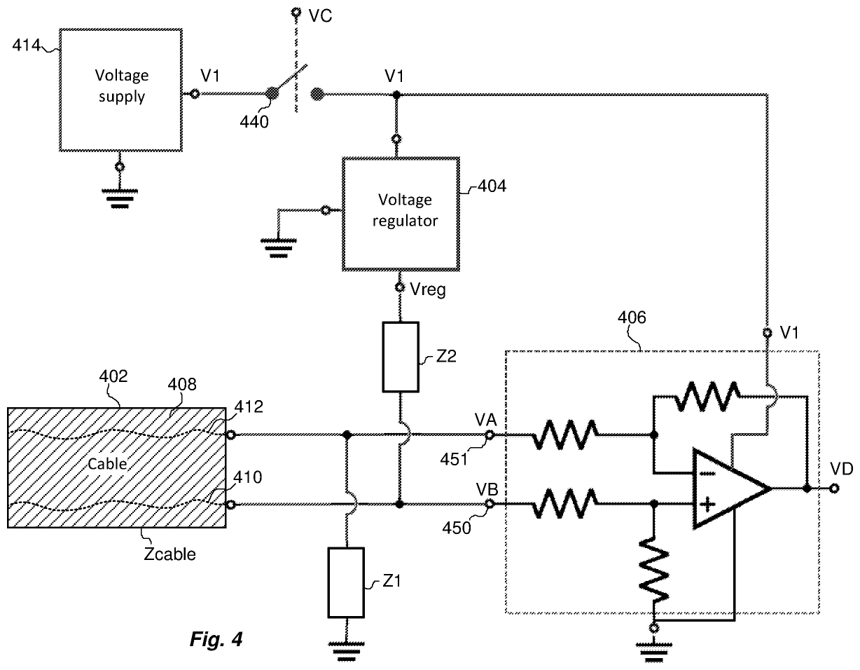

For example, as will be appreciated when considering the combined block and circuit diagram in FIG. 4, in case the cable 102 is relatively dry, the voltage drop will be relatively large and in case the cable 102 is relatively moist, the voltage drop will be relatively small. Corresponding output signals VD provided by the differential amplifier 406 will be relatively large and small, respectively.

In FIG. 4, a voltage supply 414 provides a feeding voltage V1 to a voltage regulator 404 and to a differential amplifier 406. The feeding voltage V1 may be an unregulated and hence varying voltage, e.g. as a consequence of the voltage supply 414 being a battery that is being drained. A switch 440 is controlled by a control voltage VC to provide the unregulated feeding voltage V1 to both the voltage regulator 404 and to the differential amplifier 406. The control voltage VC may for example provided by a control unit (not shown in FIG. 4) such as the control unit 120 in FIG. 1 and FIG. 2 to be described below. The voltage regulator 404 is configured to regulate the feeding voltage V1 and provide the regulated voltage Vreg to a first elongated lead 410 in the cable 402 and to a first input 450 on the differential amplifier 406 via an impedance unit that in FIG. 4 is denoted a second impedance unit Z2.

A second elongated lead 412 is connected to a second input 451 on the differential amplifier 406. An impedance unit that in FIG. 4 is denoted a first impedance unit Z1 connects the second lead 412 and the second input 451 to ground. Depending on the level of moisture in the cable 402, an impedance Zcable will be present between the two leads 410, 412 and, given the regulated voltage Vreg, a voltage difference VB-VA at the inputs 450, 451 of the differential amplifier 406 will have a value that depend on the values of Vreg, Z1, Z2 and the impedance Zcable (i.e. moisture) of the leads 410, 412 in the cable 402.

In some embodiments, the configuration of the impedance units Z1 and Z2 are such that they have substantially equal impedance values. Such embodiments have the advantage that the so-called “common mode” interference, i.e. interference received by the two leads 410, 412 from external electric fields can be suppressed to a very large extent. This advantage is further accentuated in that the two leads 410, 412 are substantially equal ion length.

As is evident from FIG. 4, details regarding the internal structure of the differential amplifier 406 are known to the skilled person and such details will not be described herein for the sake of clarity.

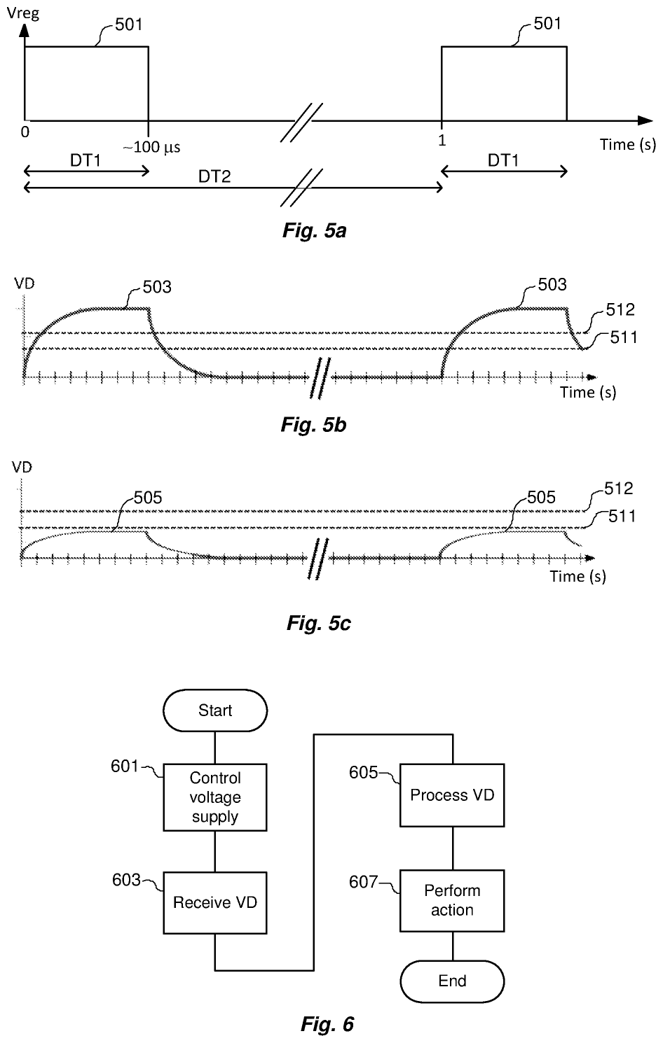

As exemplified in FIG. 5a, the regulated voltage Vreg may be in the form of constant voltage pulses having a duration DT1 and a repetition interval DT2, where DT2 is greater than DT1. For example, DT2 may be at least one order of magnitude greater than DT1. A larger ratio between DT2 and DT1 will result in a relatively smaller energy consumption from the voltage supply 414 and, vice-versa, a smaller ratio between DT2 and DT1 will result in a relatively larger energy consumption from the voltage supply 414. These constant voltage pulses having the voltage Vreg may be formed by means of the switch 440 controlled by a control unit as indicated above.

The voltage regulator 404 and the differential amplifier 406 may be configured to receive pulses of the unregulated voltage V1 from the voltage supply 414. In such embodiments, the pulses of unregulated voltage V1 may have the duration DT1 and the repetition interval DT2. This is advantageous because also the differential amplifier 406 contributes to minimizing the consumption of energy by the fact that it is in operation only during the same time intervals, i.e. during the repeated DT1 durations, as the rest of the circuitry of the system.

It is to be noted that the example of FIG. 5a, is not an indication that DT1=100 μs and DT2=1 s is a preferred DT2/DT1 configuration. The skilled person will apply suitable values on DT1 and DT2 in order to achieve a desired energy consumption while at the same time achieve a desired time resolution of the voltage pulses that provides a desired time resolution of the moisture detection.

Referring back to the discussion above in relation to FIG. 4 and with reference to FIG. 5b and FIG. 5c, FIG. 5b illustrates a signal VD 503 that is relatively large and FIG. 5c illustrates a signal VD 505 that is relatively small. The VD signals 503, 505 have a maximum level that depend on the regulated voltage Vreg as well as the resistive part of the impedances Zcable, Z1 and Z2. That is, remembering the description of the circuit in FIG. 4, FIG. 5b may be seen as exemplifying that the cable 102, 402 is relatively dry and FIG. 5c may be seen as exemplifying that the cable 102, 402 is relatively moist.

In FIGS. 5b and 5c, a detection voltage threshold 511 and a hysteresis threshold 512 are illustrated. Such thresholds 511, 512 may be utilized in a control unit, e.g. such as the control unit 120 discussed above in connection with FIG. 1, during an analysis of the signal VD in order to determine whether there is moisture or not at a location where the cable 102, 402 is located. For example, such an analysis may include a decision to provide a warning of moisture as long as the signal VD is below the detection threshold 511 and provide information that the moisture level has been reduced when the signal VD is above the hysteresis threshold 512.

With reference to the cable 102 and cable 402, schematically illustrated in FIGS. 1 and 4 respectively, the first elongated lead 110, 410 and the second elongated lead 112, 412 may have a substantially constant distance from each other along the cable 102, 402. As mentioned above, such a configuration of the two leads 110, 410, 112, 412 will ensure that the cable 102, 402 will have a constant detection sensitivity to moisture along the length of the cable 102, 402.

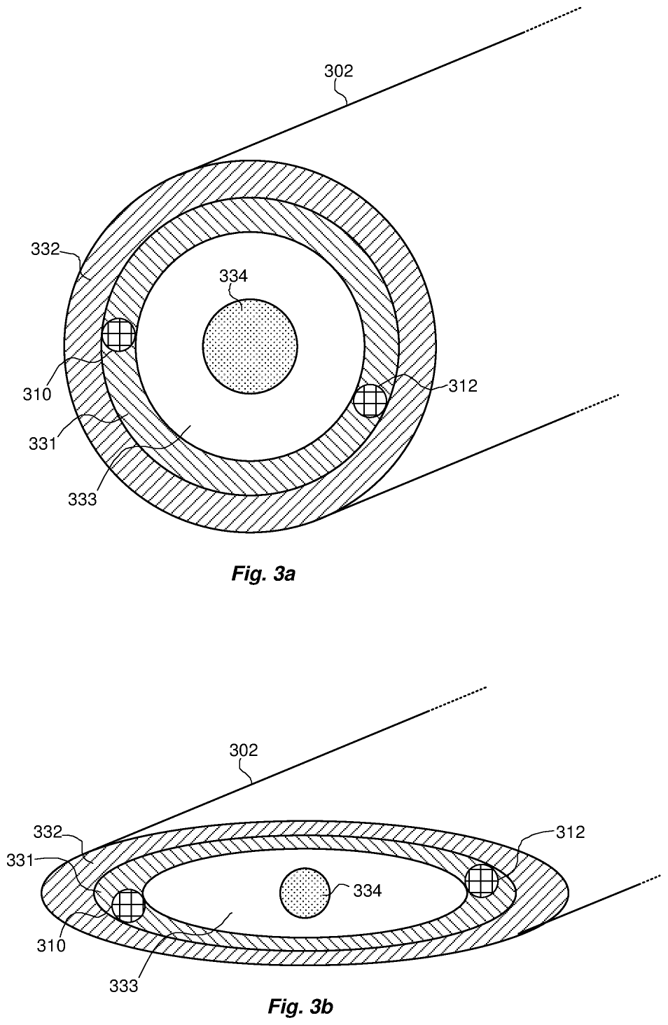

Turning now to FIG. 3a and FIG. 3b, embodiments of a cable 302 will be described. The cable 302 may correspond to the cable 102, 402 described above in connection with FIGS. 1 and 4, respectively. For example, the elongated non-conductive moisture permeable structure 108, 408 may comprise a first braid of yarn 331 and in such embodiments, a first elongated lead 310 and a second elongated lead 312, corresponding to the leads 110, 410, 112, 412 described above, are braided within said first braid of yarn 331. In some of these embodiments of the cable 302, the elongated non-conductive moisture permeable structure 108, 408 may comprise a second braid of yarn 332 arranged concentric with respect to, and covering, the first braid of yarn 331.

An effect of the second braid of yarn 332 is that it protects the two leads 310, 312 from unintentional contact with a surface on which the cable 302 is located. Such unintentional contact between leads 310, 312 and surface may otherwise result, in a worst case, in an electric short-circuit with corresponding deterioration or even a malfunction of the moisture detection.

In some embodiments, the cable 302 may comprise a glass yarn 334 arranged concentric with and covered by the first and second braids of yarn 331, 332. In some of these embodiments, the glass yarn 334 may be covered by an insulating layer 333. An effect of such embodiments is that the thickness and mechanical stability of the cable 302 may be increased. For example, an appropriately woven glass yarn 334 with an appropriately chosen thickness of the insulating layer 333 may provide the cable 302 with an appropriate flexibility and weight-to-length ratio that makes the cable 302 easy to lay down on a floor surface while making sure that the whole length of the cable 302 is in contact with the floor surface. An example of dimensions are as follows: glass yarn 334 having a diameter of 0.8 mm, covered by the insulating layer 333 up to a diameter of 2.0 mm, covered by the first braid of yarn 331 up to a diameter of 2.6 mm, covered by the second braid of yarn 332 up to a total diameter of 3.2 mm.

Any of the first braid of yarn 331 and the second braid of yarn 332 may comprises any of the materials polyester, polypropylene, nylon, textile, cotton, rayon and Kevlar. Moreover, the glass yarn 334 may be replaced by any suitable yarn or other string that provides corresponding mechanical strength to the cable 302.

As exemplified in FIG. 3b, the cable 302 may have any cross-sectional shape including a flat shape. Depending on which technique is used in braiding the yarns of the first and second braids 331, 332, any desirable cross-sectional shape may be obtained, fitting any specific spatial and mechanical requirement relating to the environment in which the cable 302 is to be installed.

In some embodiments, the elongated non-conductive moisture permeable structure 108, 408 may, instead of the braids of yarn described above, comprise any of a moisture permeable molded material and a moisture permeable filler material. For example, a molded material or filler material may have perforations (natural or machined) that allow moisture to get in contact with the two leads whereby the cable provides the moisture detection as described above. Examples of such molded and filler material include plastics such as PVC and polyethylene, foamed and fibrillated polypropylene, cotton and rayon as well as Kevlar.

In some embodiments, the two leads 310, 312 may be coated with a non-conductive, and in a liquid insoluble, moisture pervious coating (not illustrated in FIGS. 3a and 3b). Such a coating may be very thin and it would fill the purpose of additional protection against inadvertent contact between the leads 310, 312 and between any external surface or arrangement that potentially could cause a short-circuit. Such a coating may also help to prevent corrosion on the two leads 310, 312.

FIG. 2 illustrates an example of a moisture detection device 200 that comprises a voltage regulator 104 and a differential amplifier 106. As indicated by the reference numerals, these units 104, 106 may correspond to similar parts of the system 100 described above. The device 200 further comprises a control unit 120 that comprises a processor 122, a memory 124 and communication circuitry 126. A voltage supply 114 may also be part of the device 200.

As in the system 100 described above, the voltage regulator 104 is configured to supply a regulated voltage Vreg to the differential amplifier 106 and to a first lead of a cable 102. The cable 102 may correspond to any of the cables described above.

As in the system described above, the differential amplifier 106 is configured to determine a voltage difference between the first lead of the cable 102 and a second lead of the cable 102, and configured to provide a signal that is representative of the determined voltage difference to the control unit 120.

The control unit 120 is configured to process the signal provided from the differential amplifier 106 and configured to, as a result of the processing of the signal VD, perform a moisture detection related action.

In some embodiments, the action that is performed as a result of the processing of the signal VD may comprise providing the signal VD to a receiving entity 210 where it may be further analyzed and acted upon. Such a provision of the signal to the receiving entity 210 may be performed via the communication circuitry 126, which circuitry 126 may be in the form of a wireless communication circuit as well as in the form of a wired communication circuit, for example utilizing appropriate communication standard specified protocols and interfaces as the skilled person will realize.

Alternatively, the signal VD may remain in the device 200 and the moisture detection related action may in such a case entail further analysis in terms of moisture detection or, even simpler, providing a warning signal for alerting a user to the fact that the device 200 has detected moisture.

In some embodiments, the signal VD may remain locally in the device 200 for some time and also be analyzed locally by the processor 122 whereupon information resulting from such analysis may be provided to the receiving entity 210 for further action and, e.g., recording.

Turning now to FIG. 6, a method performed by a control unit will be described. The control unit that performs the method is in this example the control unit 120 that is connected to the system 100 as described above in connection with FIGS. 1 to 5. The method is illustrated in the form of a flowchart comprising a number of actions that are performed for detecting moisture. The actual execution of the various actions by the control unit is realized by way of software instructions stored in a memory and executed by a processor, e.g. the memory 124 and processor 122 in the control unit 120. The actions are as follows:

Action 601

The voltage regulator 104, 404 is controlled to supply a regulated voltage Vreg to the first lead 110, 310, 410 and to the differential amplifier 106, 406.

The regulated voltage Vreg may be in the form of constant voltage pulses having a duration DT1 and a repetition interval DT2. DT2 is greater than DT1 and, preferably, DT2 is at least one order of magnitude greater than DT1. Such pulses may be formed by the control unit 120 by controlling provision of electric energy from a voltage supply to the voltage regulator 104, 404 and, in some embodiments also to the differential amplifier 106, 406, via a simple switch, e.g. the switch 440 as described above in connection with FIG. 4.

Action 603 A signal VD that is representative of a determined voltage difference is received. As described above, the signal VD is received from the differential amplifier 106, 406 and the voltage difference is a voltage difference between the first lead 110, 310, 410 and a second lead 112, 312, 412 comprised in the cable 102, 302, 402.

Action 605

The received signal VD is processed. This processing may involve more or less complex operations. For example, a relation may be assumed, as briefly discussed above, that a small VD level may be mapped to a high level of moisture and a high VD level may be mapped to a low level of moisture. However, the VD signal may also be processed in a very minimal manner in that it remains as a voltage level.

Action 607

As a result of the processing in action 605 a moisture detection related action may be performed.

In some embodiments, the action that is performed as a result of the processing of the signal VD may comprise providing the signal VD to a receiving entity 210 where it may be further analyzed and acted upon. For example, the provision may involve transmission via a wired or wireless communication network to a user or a central server etc. where the information may be stored, further analyzed and presented in a suitable manner.

Alternatively, the signal VD may remain in the device 200 and the moisture detection related action 607 may in such a case entail further analysis in terms of moisture detection or, even simpler, providing a warning signal for alerting a user to the fact that the device 200 has detected moisture.

In some embodiments, in action 607, the signal VD may remain locally in the device 200 for some time and also be analyzed locally by the processor 122 whereupon information resulting from such analysis may be provided to the receiving entity 210 for further action and, e.g., recording.

1-20. (canceled)

21. A system for detecting moisture, comprising:
a cable comprising an elongated non-conductive moisture permeable structure, a first lead, and a second lead, the first and second leads being substantially equal in length and arranged such that they are not in galvanic contact with each other at any location along the cable;
a differential amplifier connected to the first and second leads and configured to determine a voltage difference between the first and second leads, and to provide a signal that is representative of the determined voltage difference; and
a voltage regulator configured to supply a regulated voltage to the first lead and to the differential amplifier;
wherein the elongated non-conductive moisture permeable structure comprises a first braid of yarn, and wherein the first lead and the second lead are braided within the first braid of yarn.

22. The system of claim 21 wherein the voltage regulator is configured such that the regulated voltage is provided via a second impedance unit to the first lead and to a first input on the differential amplifier; and
wherein the second lead is connected to a second input on the differential amplifier, and is connected to ground via a first impedance unit.

23. The system of claim 22, wherein the first impedance unit and the second impedance unit have substantially equal impedance values.

24. The system of claim 21, wherein the regulated voltage is in the form of constant voltage pulses having a duration DT1 and a repetition interval DT2, where DT2 is greater than DT1.

25. The system of claim 24, wherein DT2 is at least one order of magnitude greater than DT1.

26. The system of claim 24, wherein the voltage regulator and the differential amplifier are configured to receive pulses of unregulated voltage from a voltage supply, the pulses of unregulated voltage having the duration DT1 and the repetition interval DT2.

27. The system of claim 21, wherein the first lead and the second lead have a substantially constant distance from each other along the cable.

28. The system of claim 21, wherein the elongated non-conductive moisture permeable structure comprises a material selected from the group consisting of a moisture permeable molded material and a moisture permeable filler material.

29. The system of claim 21, wherein the elongated non-conductive moisture permeable structure comprises a second braid of yarn that is concentric with respect to, and covers, the first braid of yarn.

30. The system of claim 29, wherein at least one of the first braid of yarn and the second braid of yarn comprises a material selected from the group consisting of one or more of polyester, polypropylene, nylon, textile, cotton, rayon, and Kevlar.

31. The system of claim 29, wherein the cable comprises a glass yarn that is concentric with and covered by the first and second braids of yarn.

32. The system of claim 31, wherein the glass yarn is covered by an insulating layer.

33. A cable for detecting moisture, comprising:
an elongated non-conductive moisture permeable structure, a first lead, and a second lead, the first and second leads being substantially equal in length and arranged such that they are not in galvanic contact with each other at any location along the cable;
wherein the elongated non-conductive moisture permeable structure comprises a first braid of yarn, and wherein the first lead and the second lead are braided within the first braid of yarn.

34. The cable of claim 33, wherein the first lead and the second lead have a substantially constant distance from each other along the cable.

35. The cable of claim 33, wherein the elongated non-conductive moisture permeable structure comprises a material selected from the group consisting of a moisture permeable molded material and a moisture permeable filler material.

36. The cable of claim 33, wherein the elongated non-conductive moisture permeable structure comprises a second braid of yarn that is concentric with respect to, and covers, the first braid of yarn.

37. The cable of claim 36, wherein at least one of the first braid of yarn and the second braid of yarn comprises a material selected from the group consisting of one or more of polyester, polypropylene, nylon, textile, cotton, rayon, and Kevlar.

38. The cable of claim 36, wherein the cable comprises a glass yarn that is concentric with and is covered by the first and second braids of yarn.

39. The cable of claim 38, wherein the glass yarn is covered by an insulating layer.

40. A moisture detection device comprising:
a differential amplifier;
a control unit operatively connected to the differential amplifier;
a cable having a first lead and a second lead, the first lead and the second lead being of substantially equal length, and arranged so that they are not in galvanic contact with each other at any location along the cable; and
a voltage regulator configured to supply a regulated voltage to the differential amplifier and to the first lead of the cable;
wherein:
the differential amplifier is configured to determine a voltage difference between the first lead of the cable and the second lead of the cable, and to provide a signal that is representative of the determined voltage difference to the control unit;
the control unit includes a processor that is configured to process the signal and, as a result of the processing of the signal, to perform a moisture detection related action;
the cable comprises an elongated non-conductive moisture permeable structure that comprises a braid of yarn; and
the first lead and the second lead are braided within the braid of yarn.
